(19) United States
(12) Patent Application Publication
(10) Pub. No.: US 2001/0010605 A1
(43) Pub. Date: Aug. 2, 2001

(54) Read/write control system for a disk drive

(76) Inventor: Takao Aoki, Hanno-shi (JP)

Correspondence Address: Pillsbury Madison & Sutro, LLP, East Tower, Ninth Floor, 1100 New York Avenue, N.W., Washington, DC, 20005-3918, US

(21) Appl. No.: 09/769,377

(22) Filed: Jan. 26, 2001

(30) Foreign Application Priority Data
Jan. 28, 2000 (JP) 2000-020295

(51) Int. Cl. G11B 5/09

(52) U.S. Cl. 360/53; 360/31

(57) ABSTRACT

A disk drive with a retry control function of executing a retry operation when an error has occurred in a read/write operation is disclosed. According to a command from a host system, a CPU determines the upper limit of a read/write operation time for each data sector on the basis of the access range specified by the command and the time limit of the command process. Furthermore, the CPU executes a retry operation on the data sector where an error has occurred in the read/write operation. In this case, the CPU performs control so as to end or stop the retry operation within the time limited by the upper limit. The CPU, even if it cannot correct an error by the retry operation, makes the data including the error valid and starts to access the next data sector.

### CROSS-REFERENCE TO RELATED APPLICATIONS

This application is based upon and claims the benefit of priority from the prior Japanese Patent Application No. 2000-020295, filed Jan. 28, 2000, the entire contents of which are incorporated herein by reference.

### BACKGROUND OF THE INVENTION

This invention relates generally to a disk drive, such as a hard disk, and more particularly to a disk drive with a retry function of re-executing a read/write operation when an error has occurred.

A conventional disk drive, such as a hard disk drive (HDD), is provided with a retry function of re-executing the read/write operation, when an error has occurred in executing a read/write operation.

When receiving a command to specify a read operation or write operation from the host system, the disk drive executes a read/write operation of reading the data from a disk or writing the data onto a disk. The command includes the access range that specifies a plurality of data sectors on the disk to be read from or written onto. The disk drive reads or writes the data from or in each data sector included in the specified access range.

When an error has occurred in reading or writing the data from or in a certain data sector, the drive executes a retry operation of re-executing the read/write operation on the sector. The retry operation is executed repeatedly within a specific limited number of times until the proper read/write operation has been executed.

In recent years, disk drives, such as HDDs, have been used as storage devices for not only personal computers but also various digital devices, such as digital television sets. Since such a digital device processes a large amount of continuous data, such as audio data or video data, the disk drive is often used as a buffer storage device for storing the audio data or video data.

To use such a HDD to record or reproduce audio data or video data, it is necessary to secure a constant data transfer rate for the host system. In other words, a command from the host system requires such a high speed access as enables the command to be processed within a specific time.

On the other hand, when an error has occurred in accessing the computer data and the error cannot be corrected by a specific number of retry operations, an abnormal end of the command may be executed in an error process. In digital devices that record or reproduce audio data or video data, even when the data includes some errors, it is sometimes desirable that the accessed data should be transferred as it is, instead of performing an abnormal end.

Therefore, in a disk drive particularly used in a digital device for handling audio data or a video data, when an error has occurred during a read/write operation, a high-speed access operation has priority over the recovery from an error by a retry operation. In short, it is desirable to realize a high-speed read/write operation as a result of limiting the time required for a retry operation and using the data including some errors as it is.

Various control methods of limiting the number of retry operations have been developed or proposed. In those control methods, however, the time required to carry out one retry operation is not necessarily the same, because of the type of error. As a result, there is a possibility that some data sectors will be executed until the limited number of retry operations has been reached within the time limit of the command process (read/write operation), whereas some data sectors will be subjected to a retry operation a minimum number of times. In short, there is a chance that the individual data sectors included in the access range may be non-uniform in the quality of the accessed data and therefore the whole quality of the read/write data deteriorate seriously. On the other hand, when the number of retry operations on each data sector is made constant, there is a strong possibility that the time limit of the command process will be exceeded and the constant data transfer rate cannot be maintained.

### BRIEF SUMMARY OF THE INVENTION

The object of the present invention is to secure an almost uniform retry operation time for each data sector included in the access range within the time limit of a specific command process (such as a read/write operation). By doing this, it is possible to provide a disk drive capable of not only realizing a high-speed access operation but also equalizing the quality of the read/write data in each data sector.

The foregoing object is accomplished by providing a disk drive with a disk and a head, comprising: read/write means for executing a read/write operation of reading data from the disk in data sectors or writing data onto the disk in data sectors by controlling the head according to a command from a host system; means for determining the upper limit of the time usable for a read/write operation for each of the data sectors according to the number of data sectors in an access range specified by the command and a specific time limit necessary for the read/write operation on each of the data sectors to be completed; and retry control means for controlling the read/write means in such a manner that when an error has occurred during the read/write operation on each of the data sectors, a retry operation is performed on the data sector, and for performing control so as to limit the retry operation, when the total of the time spent on the read/write operation and the time required for the retry operation has exceeded the upper limit of the usable time.

As described above, the present invention realizes the retry control function of allocating almost the same retry operation executable time within the time limit of a command process (or a read/write operation) for each of the data sectors in the access range specified by a command. Therefore, in a read/write operation, a retry operation can be performed on the data sector where an error has occurred, without fail within a specific time. On the other hand, the retry operation is restricted to the time limit of the read/write operation on the data sector. Thus, the present invention is particularly effective in use with a disk drive for holding the data in a digital device that handles audio data and video data. Because the retry operation is limited, the disk drive can transfer even the data including a little error to a digital device side serving as the host system. In other words, when the data read from a disk is transferred to the host system, limiting the retry operation enables a constant data transfer rate to be secured. In addition, since a specific number of retry operations has been secured for each data sector, the quality of all the data has been almost equalized.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a block diagram showing the main parts of a disk drive according to an embodiment of the present invention;

FIG. 2 is a conceptual diagram to help explain a data track on a disk according to the embodiment;

FIG. 3 shows the relationship between the command processing time and the number of data sectors according to the embodiment; and

FIG. 4 is a flowchart to help explain the retry control operation according to the embodiment.

### DETAILED DESCRIPTION OF THE INVENTION

Hereinafter, referring to the accompanying drawings, an embodiment of the present invention will be explained.

(Configuration of Disk Drive)

A disk drive according to the embodiment is assumed to be a hard disk (HDD) used as a data storage especially for a digital device that handles audio data and video data.

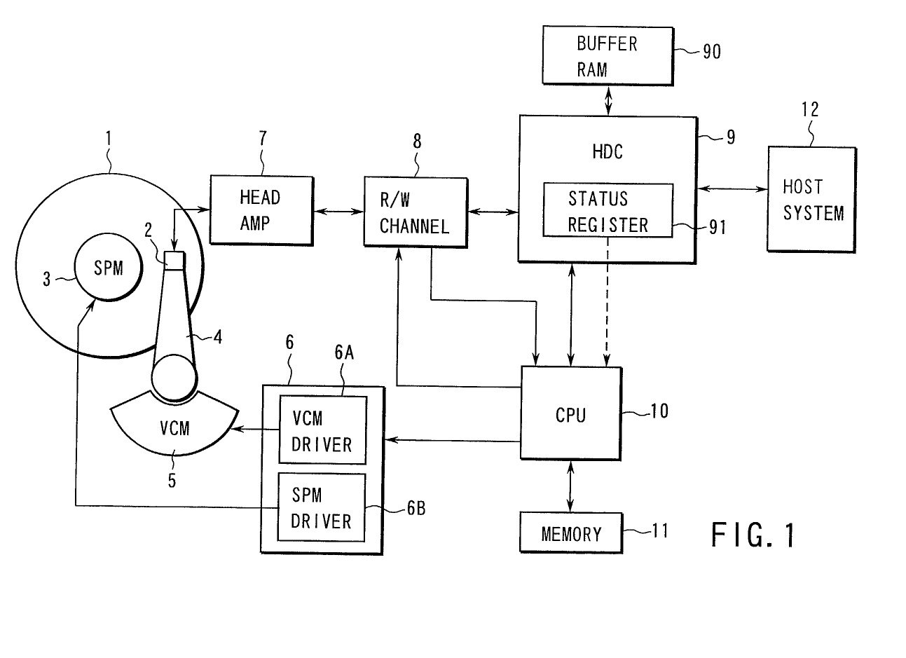

As shown in FIG. 1, the drive comprises a disk 1 serving as a data recording medium, a head 2 for recording or reproducing the data onto or from the disk 1, and a spindle motor (SPM) 3 for rotating the disk 1 at high speed.

The structure of the head 2 is such that a read head element and a write head element are provided on a slider. The head 2 is provided on an actuator 4 driven by a voice coil motor (VCM) 5. A VCM driver 6A included in a motor driver IC6 supplies a driving current to the VCM 5. The motor driver IC6, which includes not only the VCM driver 6A but also an SPM driver 6B for supplying a driving current to the SPM 3, is controlled by a microprocessor (CPU) 10 explained later.

The disk drive comprises not only the above head assembly but also a circuit system including a head amplifier circuit 7, a read/write (R/W) channel 8, a disk controller (HDC) 9, a CPU 10, and a memory 11. The head amplifier circuit 7 switches between a plurality of heads 2 and inputs and outputs read/write signals to the heads 2. The R/W channel 8 is a recording and reproducing circuit for reproducing the read data and converting the write data into a write signal.

The HDC 9 has an interface function of controlling the transfer of commands and read/write data between the drive and a host system 12 and a disk controller function of controlling the transfer of read/write data to and from the R/W circuit 8. The HDC 9 controls a buffer memory (RAM) 90 necessary for data transfer control and stores the read/write data in the buffer RAM 90 temporarily. Moreover, the HDC 9 includes an ECC circuit for executing the process of checking errors in the read data transferred from the R/W circuit 8 (in an error check process: ECC). The HDC 9 also includes a status register 91 for setting a flag indicating the occurrence of an error when the error has occurred in executing a command.

The CPU 10, which is the main control unit of the disk drive, performs read/write control, rewrite operation control, and head positioning control (or servo operation) related to the embodiment. The CPU 10 refers to various registers (including the status register 91, a command register, and an error register) of the HDC 9 and deciphers and executes the command (read/write command) transferred from the host system 12. The error register holds the data indicating the type of an error occurred during the execution of the command. The memory 11, which is a rewritable nonvolatile memory, such as a flash memory, holds various data items necessary to control the CPU 10.

The host system 12 means, for example, a digital television set composed of a computer capable of recording or reproducing audio data and video data.

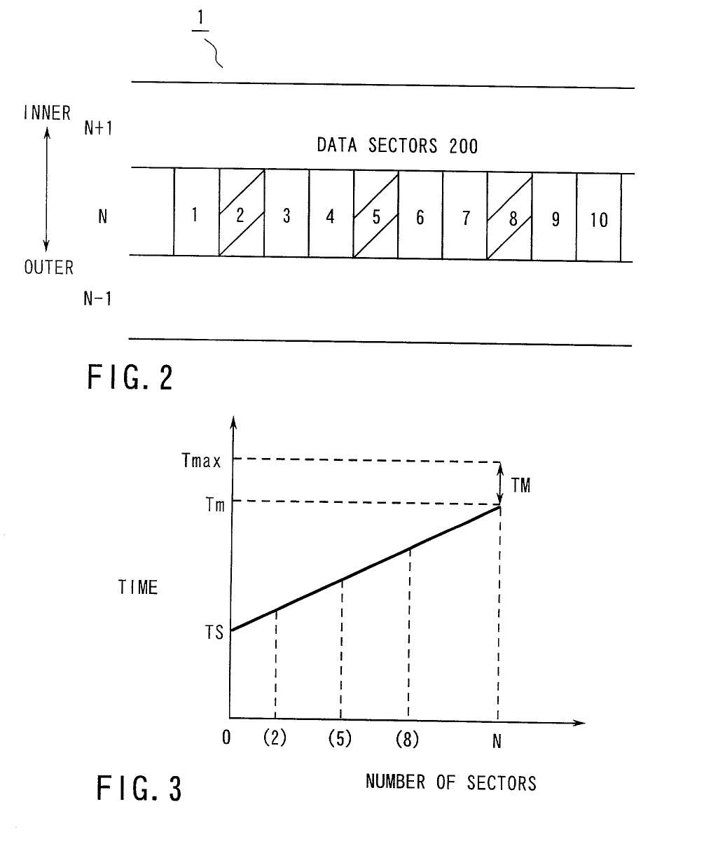

On the disk 1, a data track group is constructed as shown in FIG. 2 in such a manner that track numbers (cylinder numbers) are allocated to tracks consecutively from the outer edge side to inner edge side. Each of the data tracks (N−1, N, N+1) is divided into a plurality of logically consecutive sectors (assumed to be 1 to 10, in this case) 200. In practice, each data track is composed of servo areas placed at specific intervals and data sectors arranged between the servo areas. In each servo area, servo data used for head positioning control is recorded. In each data sector, user data is recorded.

(Command Process and Retry Control Operation)

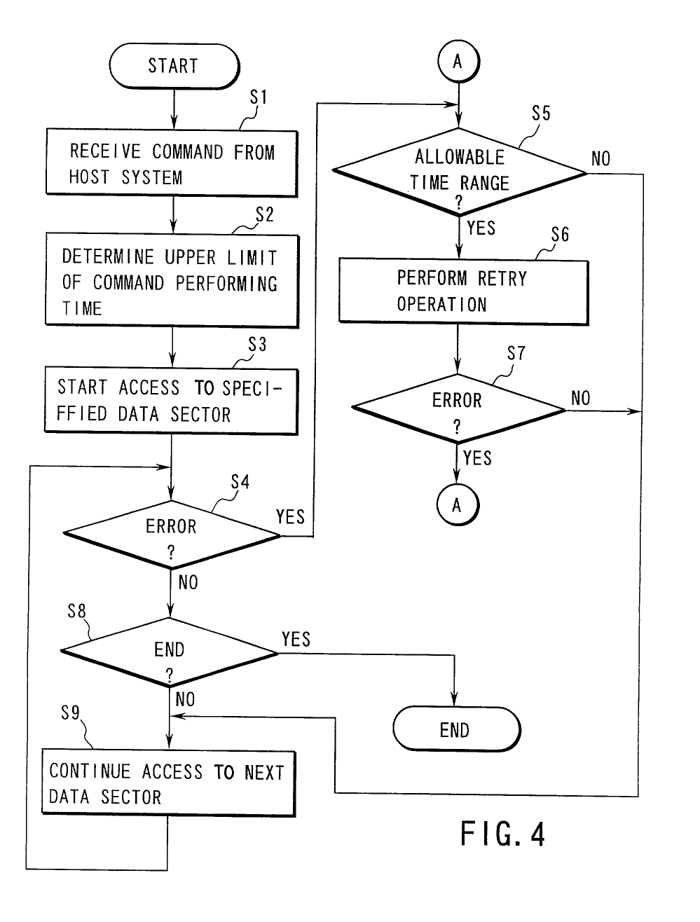

Hereinafter, referring to FIGS. 1 to 4, the retry control operation in the embodiment will be explained.

First, when receiving a command (assumed to be a read command) from the host system 12, the HDC 9 sets the command in the command register (step S1). The CPU 10 not only refers to the command register and decodes the read command but also recognizes each of the data sectors included in the access range specified by the command. In practice, since the command specifies the begin data sector (for example, number 1) and the number of blocks (the number of data sectors), the CPU 10 determines the number of data sectors (assumed to be 10) to be accessed consecutively from the begin data sector (1).

Under the control of the host system, the CPU 10 determines the upper limit (Tmax shown in FIG. 3) of the executing time of the command process. The upper limit (Tmax) means the maximum time limit until the read operation has been completed for each of the data sectors (sector numbers 1 to 10 in this case) included in the access range. The read operation is assumed to be the operation from when the data is read from the disk until the data is transferred to the host system 12. Specifically, the upper limit (Tmax) is the value determining the longest time during which the command to read the recorded data (sector data) from the begin data sector (1) to the last data sector (10) and transfer the data to the host system should be completed.

Furthermore, in the embodiment, the CPU 10 determines the upper limit time of a read/write operation (in this case, a read operation) for each data sector on the basis of the upper limit (or the time limit Tmax) of the executing time of the command process and the number of data sectors (10) in the access range (step S2). That is, the CPU 10 determines the upper limit time at which the read operation should be completed, for each of the consecutive data sectors from the execution start time (access start point of time) of the command.

In practice, if the abscissa axis indicates the number of data sectors (N) and the ordinate axis indicates the executing time (read/write operation time) of the command process, the upper limit time will be obtained from a linear function using the number of data sectors (N) as a variable. Here, the upper limit time (time Tm) at which the read operation of the last data sector N (number 10 in this case) should be completed within the time limit (Tmax) of the command process is determined, taking into account a margin for absorbing overheads from the time limit (Tmax). The initial value (time Ts) is a constant occupying a specific proportion of the time limit (Tmax). This is for securing the time of a retry operation, if an error occurs near the beginning of the access range.

After the initial setting has been done, the CPU 10 starts a timer (an internal timer) for monitoring the read operation time for each sector and starts the execution of the command (the read command in this case) (step S3). Specifically, the CPU 10 controls the actuator 4 via the VCM driver 6A, thereby positioning the head 2 on the target track (N). Then, the CPU causes the head 2 to execute the read operation of reading the data sequentially. That is, the head starts to access the individual data sectors (sector numbers 1 to 10) in the access range specified by the command, starting at the begin sector (assumed to be number 1).

When no error has occurred in reading each of the data sectors, the CPU 10 accesses the data sectors consecutively until the last data sector (10) in the access range has been reached (NO at step S4, and steps S8 and S9). After the data read from the last data sector (10) is transferred to the host system via the R/W channel 8 and HDC 9, the command is completed (YES at step S8).

On the other hand, in FIG. 2, for example, it is assumed that a read error has occurred in accessing the data sector with sector number 2. When a read error (for example, ECC error) has occurred in accessing the data sector with sector number 2, the CPU 10 prepares to execute a retry operation (a read retry operation) (YES at step S4). The access error is set in the status register 91 of the HDC 9. The CPU 10 can recognize the occurrence of the error by referring to the status register 91.

The CPU 10 refers to the elapsed time on the timer and the upper limit time (see FIG. 3) of each data sector determined in the process at step S2, thereby determining whether the time limit has been exceeded (step S5). If the time limit has not been exceeded, the CPU 10 carries out a retry operation to execute the read operation again on the data sector (number 2) where an error has occurred (step S6). The CPU 10, if the time limit has not been exceeded, repeats the retry operation until the data has been read properly (YES at step S7 and steps S5 and S6).

The HDC 9 supplies an interrupt signal to the CPU 10, when an error has occurred or when the reading is done properly. When not receiving the interrupt within a specific time, the CPU 10 judges that some error has occurred and starts a retry operation. The upper limit of the time during which the CPU 10 waits for the interrupt is the smaller of a predetermined constant value and the upper limit time of each data sector. The upper limit is so set that even when the interrupt has not occurred, the time required to access the data sector does not exceed the upper limit time.

When the error has been corrected by the retry operation, the CPU 10 accesses the relevant data sector (sector number 2) to the last data sector (sector number 10) consecutively (NO at step S7 and step S9).

On the other hand, if the error has not been corrected within the upper limit time, the CPU 10 stops accessing (or reading) the relevant data sector (sector number 2) and starts to access the beginning of the next data sector (sector number 3 in this case) (NO at step S5 and step S9). In this case, the CPU 10 performs control in such a manner that the error from the data sector (sector number 2) is transferred as it is to the host system.

Similarly, the CPU 10 accesses the relevant data sector (sector number 3) to the last data sector (sector number 10) consecutively (NO at step S4). If an error has occurred in accessing the data sector with sector number 5 or sector number 8, the CPU 10 repeats the retry operation as many times as possible within the time limit (steps S5 to S7). In executing the retry operation, the CPU 10 carries out the process of adjusting the track offset of the head 2, the process of adjusting the parameters included in the R/W channel 8.

When the retry operation has failed to correct the error within the upper limit time, the CPU 10 stops accessing (or reading) the data sector (sector number 5 or 8) and starts to access the beginning of the next data sector (sector number 6 or 9) (step S9).

As described above, the CPU 10 uses the timer to monitor the time elapsed since the start of access and checks the command execution time limit and the upper limit time of access to each of the individual data sectors in the access range. As a result, if an error has occurred in a data sector, the CPU 10 executes a retry operation on the condition that the number of retry operations is limited within the predetermined upper time. If the retry operation has failed to correct the error within the upper limit time, the CPU 10 starts to access the next data sector. Herein, when the error has not been corrected, the CPU 10 transfers the data including the error to the host system. Alternatively, when the error has not been corrected, the CPU 10 may remove the data from the data sector from the transferred data and stop the command because of abnormality. In the embodiment, the read command (read operation) has been assumed in executing a command (or carrying out the access process). The same holds true for the write command (write operation). In the write operation, when a write fault preventing the data from being written has occurred, the CPU 10 executes a retry operation. If the retry operation has not succeeded within the time limit, the CPU 10 stops the retry operation (or does not record the data).

In the embodiment, the retry operation is limited within the specific upper limit time for each of the data sectors in the process of accessing each of the data sectors included in the access range. Therefore, even if an access error occurs, the execution of a command can be ended within the specific time limit. This enables continuous data, such as audio data or video data, to be transferred to the host system at a specific transfer rate. Furthermore, since the number of retry operations can be secured to a certain extent within the upper limit time, the data of sufficient quality as a whole can be transferred without degrading the quality of the transfer data so much.

As described above, with the present invention, an almost uniform retry operation time can be secured for each of the data sectors included in the access range within the command execution time limit. As a result, it is possible to secure the quality of the transfer data sufficiently without decreasing the constant data transfer rate or degrading the quality of the data so much. Consequently, the present invention is particularly suitable for the recording and reproducing of continuous data, such as audio data or video data.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk drive with a disk and a head, comprising:
read/write means for executing a read/write operation of reading data from said disk in data sectors or writing data onto said disk in data sectors by controlling said head according to a command from a host system;
means for determining the upper limit of the time usable for a read/write operation for each of the data sectors according to the number of data sectors in an access range specified by said command and a specific time limit necessary for the read/write operation on each of the data sectors to be completed; and
retry control means for controlling said read/write means in such a manner that when an error has occurred during the read/write operation on each of said data sectors, a retry operation is performed on the data sector, and for performing control so as to limit the retry operation, when the total of the time spent on said read/write operation and the time required for the retry operation has exceeded the upper limit of said usable time.

2. The disk drive according to claim 1, wherein said retry control means stops said retry operation, when the upper limit of said usable time allocated to the data sector in executing the retry operation.

3. The disk drive according to claim 1, wherein said retry control means limits the number of retry operations on the data sector so as to end said retry operation within the range of the time obtained by subtracting the time spent on said read/write operation from the upper limit of said usable time.

4. The disk drive according to claim 1, wherein said determining means, if said number of data sectors is set as a variable, calculates said upper limit in the form of a liner function.

5. The disk drive according to claim 1, further comprising means for, when said command is a read command and said retry control means has failed to correct an error by said retry operation within the upper limit of said usable time, transferring the data read from the data sector by said read/write means to said host system as the correct read data.

6. The disk drive according to claim 1, further comprising means for, when said retry control means has failed to correct an error by said retry operation within the upper limit of said usable time, stopping said read/write means from performing a read/write operation on the data sector and starting a read/write operation on the next data sector in said access range.

7. A method of controlling a read/write operation in a disk drive with a disk and a head, the method comprising:
the step of receiving from a host system a command to specify a read/write operation of reading data from the data sectors in a specified access range on said disk or writing data onto said disk;
the step of determining the upper limit of usable time for a read/write operation on each of the data sectors according to the number of data sectors in said access range and a specific time limit required for a read/write operation on each of said data sectors to be completed; and
the step of, when an error has occurred in a read/write operation on each of said data sectors, executing a retry operation on the data sector within the upper limit of said usable time.

8. The method according to claim 7, further comprising the step of stopping said retry operation, when the time required for said retry operation has exceeded said upper limit.

9. The method according to claim 7, further comprising the step of limiting said number of retry operations, when the total of the time spent on a read/write operation on a data sector where an error has occurred and the time necessary for the retry operation has exceeded the upper limit of said usable time in executing said retry operation.

10. The method according to claim 7, further comprising the step of, when an error cannot be corrected by said retry operation within the upper limit of said usable time, stopping the retry operation on the data sector and starting a read/write operation on the next data sector included in said access range.
